(19) United States
(12) Patent Application Publication
(10) Pub. No.: US 2007/0178025 A1
(43) Pub. Date: Aug. 2, 2007

(54) Exhaust treatment system

(76) Inventor: Cornelius N. Opris, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/342,657

(22) Filed: Jan. 31, 2006

(51) Int. Cl. B01D 50/00; B01D 53/34

(52) U.S. Cl. 422/177; 422/180

(57) ABSTRACT

An exhaust treatment system of a power source includes a filter fluidly connected to an exhaust outlet of the power source. The filter includes a housing and a substrate disposed within the housing. A catalyst material is disposed on the substrate. The exhaust treatment system also includes a reactant assembly including a reactant supply controllably fluidly connectable to the catalyst material. The exhaust treatment system further includes a clean-up catalyst downstream of the catalyst material and a recirculation line configured to direct a portion of a filtered exhaust flow to an intake of the power source.

### TECHNICAL FIELD

The present disclosure relates generally to an exhaust treatment system and, more particularly, to an exhaust treatment system having a selective catalytic reduction catalyst.

### BACKGROUND

Internal combustion engines, including diesel engines, gasoline engines, natural gas engines, and other engines known in the art, may exhaust a complex mixture of air pollutants. The air pollutants may be composed of gaseous compounds, which may include nitrous oxides (“NOx”), and solid particulate matter, which may include unburned carbon particulates called soot.

Due to increased attention on the environment, exhaust emission standards have become more stringent, and the amount of gaseous compounds emitted to the atmosphere from an engine may be regulated depending on the type of engine, size of engine, and/or class of engine. One method that has been implemented by engine manufacturers to comply with the regulation of these engine emissions is exhaust gas recirculation (“EGR”). EGR systems recirculate the exhaust gas byproducts into the intake air supply of the internal combustion engine. The exhaust gas directed to the engine cylinder reduces the concentration of oxygen within the cylinder and increases the specific heat of the air/fuel mixture, thereby lowering the maximum combustion temperature within the cylinder. The lowered maximum combustion temperature and reduced oxygen concentration can slow the chemical reaction of the combustion process and decrease the formation of NOx.

In many EGR applications, the exhaust gas is passed through multiple selective catalytic reduction catalysts and an assembly configured to inject urea and/or ammonia into the exhaust flow. The selective catalytic reduction catalysts may be useful in absorbing, adsorbing, and/or chemically reducing NOx contained within the exhaust gas flow in the presence of urea and/or ammonia. Such exhaust treatment systems, however, may be costly, complex, and difficult to package due to the number of catalysts and other components required, and as additional catalysts are added to such systems, the pressure drop across the system may greatly increase. In addition, such systems may recirculate exhaust gas to the intake of the engine without filtering harmful particulate matter from the recirculated flow. Drawing recirculated particulates into the combustion chamber of the engine may clog and/or otherwise damage engine components over time and may reduce the efficiency of the combustion reaction within the combustion chamber. On the other hand, adding a particulate filter to such a multiple catalyst system may further increase the pressure drop across the system and may increase the size, cost, and complexity of the system.

As shown in U.S. Pat. No. 6,209,317 (“the '317 patent”), a catalyst system can be used to treat a flow of engine exhaust gas before a portion of the gas is fed back to an intake air stream of the engine. Specifically, the '317 patent discloses an engine configured to direct a flow of exhaust through an HC absorbing device. A portion of the exhaust is extracted downstream of the HC absorbing device and is directed to an intake of the engine through a recirculation loop. The remainder of the exhaust is then directed to a NOx catalyst converter.

Although the system of the '317 patent may reduce the quantity of NOx released to the environment, the system may not remove the harmful particulate matter contained within the recirculated exhaust flow before the flow is directed to the intake of the engine.

The disclosed exhaust treatment system is directed to overcoming one or more of the problems set forth above.

### SUMMARY OF THE INVENTION

In an exemplary embodiment of the present disclosure, an exhaust treatment system of a power source includes a filter fluidly connected to an exhaust outlet of the power source. The filter includes a housing and a substrate disposed within the housing. A catalyst material is disposed on the substrate. The exhaust treatment system also includes a reactant assembly including a reactant supply controllably fluidly connectable to the catalyst material. The exhaust treatment system further includes a clean-up catalyst downstream of the catalyst material and a recirculation line configured to direct a portion of a filtered exhaust flow to an intake of the power source.

In another exemplary embodiment of the present disclosure, an exhaust treatment system of a power source includes a filter fluidly connected to an exhaust outlet of the power source. The filter includes a housing and a substrate disposed within the housing. A catalyst material is disposed on the substrate. The exhaust treatment system also includes a reactant assembly including a reactant supply controllably fluidly connectable to the catalyst material. The exhaust treatment system further includes a clean-up catalyst downstream of the catalyst material and an energy extraction assembly disposed upstream of the filter and fluidly connected to the exhaust outlet of the power source.

In still another exemplary embodiment of the present disclosure, a method of treating an exhaust flow of a power source includes providing a filter fluidly connected to an exhaust outlet of the power source. The filter includes a catalyst material disposed on a substrate, and the substrate has a porosity between approximately 55% and approximately 90% in a bare state. The method also includes filtering a first portion of the exhaust flow with the substrate and adding a reactant to the exhaust flow upstream of the catalyst material. The method further includes chemically reducing a second portion of the exhaust flow in the presence of the reactant and the catalyst material.

### BRIEF DESCRIPTION OF THE DRAWINGS

FIG. 1 is a diagrammatic illustration of a power source having an exhaust treatment system according to an exemplary embodiment of the present disclosure.

### DETAILED DESCRIPTION

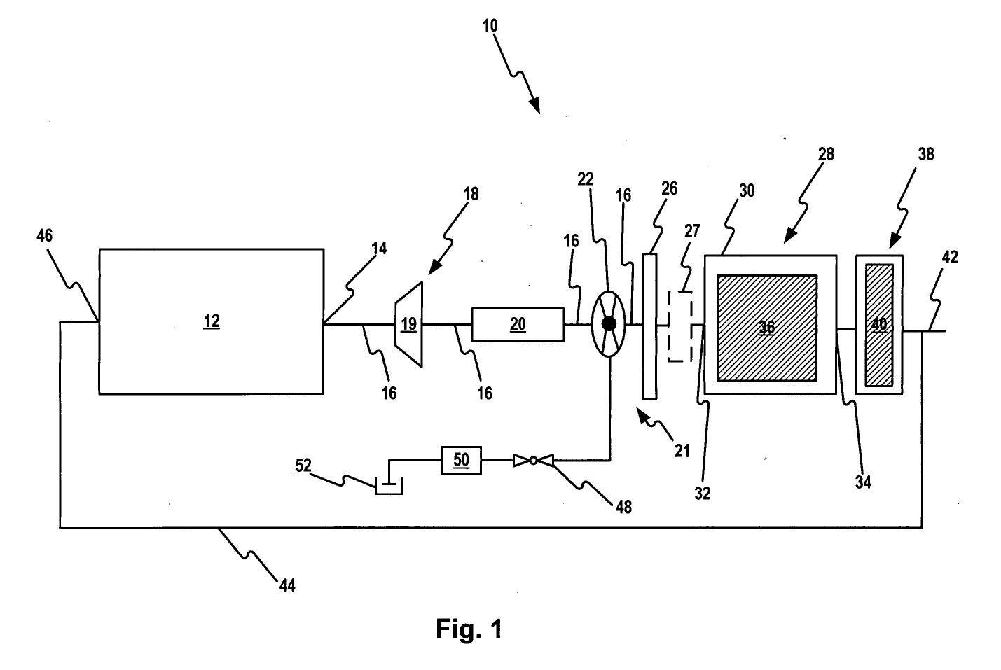

FIG. 1 illustrates a power source 12 having an exemplary exhaust treatment system 10. The power source 12 may include an engine, such as, for example, a diesel engine, a gasoline engine, a natural gas engine, or any other engine apparent to one skilled in the art. The power source 12 may, alternately, include another source of power, such as a furnace, or any other source of power known in the art.

The exhaust treatment system 10 may be configured to direct exhaust gases out of an exhaust outlet 14 of the power source 12, treat the gases, and introduce a portion of the treated gases into an intake 46 of the power source 12. The exhaust treatment system 10 may include an energy extraction assembly 18, a regeneration assembly 20, a reactant assembly 21, and a mixer 26. The exhaust treatment system 10 may also include a filter 28, a clean-up catalyst 38, and a recirculation line 44 fluidly connected between the clean-up catalyst 38 and a system outlet 42. The system outlet 42 may be configured to release treated exhaust gases to the environment through, for example, an exhaust pipe of a work machine, and the recirculation line 44 may be configured to assist in directing a portion of the treated exhaust gases to the intake 46 of the power source 12.

A flow of exhaust produced by the power source 12 may be directed from the power source 12 to components of the exhaust treatment system 10 by flow lines 16. The flow lines 16 may include pipes, tubing, and/or other exhaust flow carrying means known in the art. The flow lines 16 may be made of alloys of steel, aluminum, and/or other materials known in the art. The flow lines 16 may be rigid or flexible, and may be capable of safely carrying high temperature exhaust flows, such as flows having temperatures in excess of 700 degrees Celsius (approximately 1,292 degrees Fahrenheit).

The energy extraction assembly 18 may be configured to extract energy from, and reduce the pressure of, the exhaust gases produced by the power source 12. The energy extraction assembly 18 may be fluidly connected to the power source 12 by one or more flow lines 16 and may reduce the pressure of the exhaust gases to any desired pressure. The energy extraction assembly 18 may include one or more turbines 19, diffusers, or other energy extraction devices known in the art. In an exemplary embodiment wherein the energy extraction assembly 18 includes more than one turbine 19, the multiple turbines (not shown) may be disposed in a parallel or series relationship. It is also understood that in an embodiment of the present disclosure, the energy extraction assembly 18 may, alternately, be omitted. In such an embodiment, the power source 12 may include, for example, a naturally aspirated engine. It is understood that a component of the energy extraction assembly 18 may be configured in certain embodiments to drive a component of a compression assembly (not shown), such as, for example, a compressor. In such exemplary embodiments, the compression assembly may assist in increasing the pressure of exhaust gases before the gases enter the intake 46 of the power source 12.

The regeneration assembly 20 may be fluidly connected to the energy extraction assembly 18 via flow line 16 and may be configured to increase the temperature of a flow of exhaust produced by the power source 12 to a desired temperature. The desired temperature may be, for example, a regeneration temperature of the filter 28. Accordingly, the regeneration assembly 20 may be configured to assist in regenerating the filter 28. The regeneration assembly 20 may include, for example, a fuel injector and an igniter (not shown), heat coils (not shown), and/or other heat sources known in the art. Such heat sources may be disposed within the regeneration assembly 20 and/or within a housing 30 of the filter 28, and may be configured to assist in increasing the temperature of the flow of exhaust through convection, combustion, and/or other methods.

In an exemplary embodiment in which the regeneration assembly 20 includes a fuel injector and an igniter, it is understood that the regeneration assembly 20 may receive a supply of a combustible substance and a supply of oxygen to facilitate combustion within the regeneration assembly 20. The combustible substance may be, for example, gasoline, diesel fuel, reformate, and/or any other combustible substance known in the art. The supply of oxygen may be provided in addition to the relatively low pressure flow of exhaust gas directed to the regeneration assembly 20 through flow line 16. In an exemplary embodiment, the supply of oxygen may include, for example, recirculated exhaust gas and/or ambient air.

In an additional exemplary embodiment, the regeneration assembly 20 may be omitted. In such an exemplary embodiment, the temperature of the exhaust gases passing through the filter 28 may be increased through wastegating, throttling, and/or other power source control methods. Such control methods may be utilized to passively regenerate the filter 28 at desired intervals.

It is understood that the regeneration assembly 20 of the exhaust treatment system 10 may also include a catalyst 27 (shown in phantom), such as, for example, an oxidation catalyst fluidly connected to the filter 28 and disposed, for example, upstream of the filter 28 and downstream of the mixer 26. The catalyst 27 may include any conventional catalyst materials, such as, for example, platinum and/or palladium. The catalyst 27 may produce nitrogen dioxide as a flow of exhaust gases passes therethrough during operation of the power source 12. The nitrogen dioxide produced by the catalyst 27 may assist in passively regenerating the filter 28 during operation of the power source 12. In addition, the exhaust treatment system 10 may also include an additional injection device (not shown) upstream of the catalyst configured to inject, for example, fuel or other reductants into a flow of exhaust gas. The injection device may be similar to the injector 22 discussed in greater detail below. Alternatively, one or more of the fuel injectors in a combustion chamber of the power source 12 may be used to inject fuel or other reductants during an exhaust stroke of a cylinder of the power source 12. In such an embodiment, an additional injection device may not be needed. As yet another alternative, in an embodiment including both a catalyst 27 and a regeneration assembly 20, one or more injection devices of the regeneration assembly 20 may be used to inject fuel or reductants upstream of the catalyst 27. The injected reductants may facilitate an exothermic chemical reaction with the materials contained within the catalyst and the hydrocarbons contained within the exhaust flow. Controlling the amount of reductant injected may assist in controlling, for example, the amount of heat produced in the chemical reaction, and the heat produced may be sufficient to actively regenerate the filter 28.

In an exemplary embodiment of the present disclosure, the reactant may be in a substantially fluid state. In such an embodiment, the reactant assembly 21 may include one or more valves 48 or other flow control devices, an injector 22, a pump 50, and a reactant supply 52. The valves 48 may be disposed proximate the injector 22, and the valves 48 may be configured to controllably release a quantity of fluid reactant into an exhaust flow of the power source 12 through the injector 22. The valves 48 may be fluidly connected to the pump 50, and the pump 50 may be configured to draw reactant from the reactant supply 52 and to direct the reactant to the injector 22. The pump 50 may be any type of conventional pump and the reactant supply 52 may be, for example, a tank, sump, canister, housing, and/or any other type of container configured to safely store reactants. The reactant supply 52 may be controllably fluidly connectable to, for example, the components of the filter 28 described in greater detail below. It is understood that the pump 50 and/or the valves 48 may be electrically connected to a controller (not shown) configured to control the operation thereof. Thus, the controller, the pump 50, and/or the valves may assist in controllably fluidly connecting the reactant supply 52 to, for example, the components of the filter 28.

The injector 22 may include a nozzle 24 or other flow control device configured to assist in controllably releasing a flow of fluid reactant into an exhaust flow of the power source 12. The nozzle 24 may be, for example, a pressure swirl, air assist, air blast, dual orifice, and/or any other type of injector known in the art. The nozzle 24 may include, for example, a fluid atomization device, and/or any other device capable of injecting and/or atomizing an injected fluid. In an exemplary embodiment, an end of the nozzle 24 may define a plurality of holes sized, positioned, and/or otherwise configured to facilitate the formation of a relatively fine mist and/or spray of injected fluid. The nozzle 24 may be configured to substantially evenly distribute the injected fluid within, for example, the flow line 16 or other components of the exhaust treatment system 10 to facilitate a substantially uniform mixing between the injected fluid and the exhaust flow. The nozzle 24 may also be configured to distribute the injected fluid at a desired angle within the flow line 16 or other exhaust treatment system 10 components.

As shown in FIG. 1, the exhaust treatment system 10 may also include a mixer 26 configured to assist in mixing the injected reactant substantially uniformly with the exhaust flow. The mixer 26 may be disposed downstream of the injector 22 and may be any shape or configuration capable of inducing turbulence in a fluid passing therethrough. The mixer 26 may be, for example, substantially conical or substantially disc-shaped, and may have one or more veins, holes, slits, fins, and/or any other structures known in the art. In an exemplary embodiment of the present disclosure, the mixer 26 may also have one or more moving parts. The mixer 26 may be, for example, an impeller-type mixer, a diffuser-type mixer, and/or any other type of mixer known in the art. It is understood that, in an alternative embodiment, the mixer 26 may be omitted. In such an embodiment, the exhaust treatment system 10 may include an additional length of flow line 16 disposed downstream of the injector 22 to facilitate the mixing of the injected reactant and the exhaust flow.

In an additional exemplary embodiment, the reactant may be in substantially solid form. In such an embodiment, the injector 22, valves 48, and pump 50 may be omitted, and the reactant assembly 21 may include, for example, the reactant supply 52. The substantially solid reactant may be stored in the reactant supply 52, and the reactant supply 52 may be controllably fluidly connectable to, for example, the components of the filter 28 described below. For example, the reactant supply 52 may include flow doors (not shown), gates (not shown), and/or other flow control devices. Such flow control devices may control the flow of exhaust from the power source 12 through a portion of the reactant supply 52 and may regulate the quantity of reactant exposed to the flow. Controlling the quantity of the substantially solid reactant exposed to the exhaust flow may assist in controllably releasing the reactant into the flow.

The reactant discussed above may be urea, ammonia, and/or other elements or compounds capable of chemically reducing, for example, oxides of nitrogen contained within an exhaust flow. In an additional embodiment, the reactant may be, for example, hydrocarbon and/or carbon monoxide, and such reactants may be produced by the power source 12 and carried in the exhaust flow. Thus, the reactant supply 52 may include a quantity of at least one of hydrocarbon, carbon monoxide, ammonia, and urea. Such reactants may assist in chemically reducing oxides of nitrogen in the presence of, for example, catalyst materials disposed on a substrate of a filter. Such selective catalytic reduction reactions are known in the art and will not be discussed in great detail here.

As shown in FIG. 1, the filter 28 may be connected downstream of the regeneration assembly 20, the reactant assembly 21, and/or the mixer 26. The housing 30 of the filter 28 may include an inlet 32 and an outlet 34. In an exemplary embodiment, the regeneration assembly 20, the injector 22, and/or the mixer 26 may be disposed outside of the housing 30 and may be fluidly connected to the inlet 32 of the housing 30. In another exemplary embodiment, the regeneration assembly 20, the injector 22, and/or the mixer 26 may be disposed within the housing 30 of the filter 28. The filter 28 may be any type of filter known in the art capable of filtering, physically separating, and/or extracting matter from a flow of gas. In an embodiment of the present disclosure, the filter 28 may be, for example, a particulate matter filter positioned to filter, physically separate, and/or extract particulates from an exhaust flow of the power source 12. The filter 28 may include, for example, a substrate 36. The substrate 36 may be, for example, substantially ceramic, substantially metallic, mesh, foam, and/or any other porous material or structure known in the art. In an exemplary embodiment, the substrate 36 may include cordierite and/or other conventional metals used in diesel particulate filters. The substrate 36 may form, for example, a honeycomb structure within the housing 30 of the filter 28 to facilitate the filtering and/or removal of particulates from the exhaust flow of the power source 12. The particulates may be, for example, soot and/or soluble organic fraction.

In an embodiment, a catalyst material (not shown) may be disposed on the substrate 36 of the filter 28. It is understood that disposing the catalyst material on the substrate 36 may at least partially clog some of the pores, channels, and/or other passages of the substrate, and may thereby reduce the porosity of the substrate 36. In an exemplary embodiment of the present disclosure, a filter 28 having catalyst material disposed on the substrate 36 may be referred to as a “catalyzed” filter, and the substrate 36 of such a filter 28 may have a porosity between approximately 40% and approximately 80% in a catalyzed state. In an uncatalyzed or “bare” state, however, an exemplary substrate 36 of the filter 28 may have a porosity between approximately 50% and approximately 90%. The catalyst material may include, for example, venadium, precious metals, base metal oxides, and/or other nonprecious metals useful in collecting, absorbing, adsorbing, storing, and/or chemically reducing oxides of sulfur, hydrocarbons, carbon monoxide, soluble organic fraction, and/or oxides of nitrogen contained in a flow. The catalyst materials may be situated within the substrate 36 so as to maximize the surface area available for the reduction of, for example, NOx. As mentioned above, reactants such as, for example, hydrocarbons, carbon monoxide, urea, and ammonia supplied by, for example, the reactant assembly 21 may assist in this selective catalytic reduction process.

The exhaust treatment system 10 may further include a clean-up catalyst 38 disposed downstream of the substrate 36. The clean-up catalyst 38 may contain catalyst materials useful in collecting, absorbing, adsorbing, storing, and/or chemically oxidizing unburned hydrocarbons, urea, carbon monoxide, and/or ammonia contained in a fluid flow. Such catalyst materials may include, for example, aluminum, platinum, palladium, rhodium, barium, cerium, and/or alkali metals, alkaline-earth metals, rare-earth metals, or combinations thereof. The catalyst materials may be situated within the clean-up catalyst 38 so as to maximize the surface area available for the oxidation of, for example, unburned hydrocarbons. The clean-up catalyst 38 may include, for example, a substrate 40. The substrate 40 may include any porous material known in the art and may be, for example, substantially ceramic, substantially metallic, mesh, or foam. As described above with respect to the filter 28, the catalyst materials of the clean-up catalyst 38 may be located on the substrate 40. It is understood that although the catalyst materials of the clean-up catalyst 38 may assist in the formation of sulfate, the presence of these catalyst materials in the clean-up catalyst 38 may improve the overall emissions characteristics of the exhaust treatment system 10 by removing, for example, hydrocarbons from the treated exhaust flow.

Referring again to FIG. 1, the exhaust treatment system 10 may further include a recirculation line 44 fluidly connected downstream of the filter 28 and the clean-up catalyst 38. Alternatively, the recirculation line 44 may also be disposed between the filter 28 and the clean-up catalyst 38. The recirculation line 44 may be configured to assist in directing a portion of the exhaust flow from the filter 28 to the intake 46 of the power source 12. The recirculation line 44 may comprise piping, tubing, and/or other exhaust flow carrying means known in the art, and may be structurally similar to the flow lines 16 described above.

### INDUSTRIAL APPLICABILITY

The exhaust treatment system 10 of the present disclosure may be used with any combustion-type device, such as, for example, an engine, a furnace, or any other device known in the art where the capture and/or treatment of particulates, oxides of nitrogen, and/or other exhaust components is desired. The exhaust treatment system 10 may also be configured to maximize the amount of catalytic activity per unit volume of the filter 28 while, at the same time, maximizing the filtration efficiency of the filter 28 and minimizing the pressure drop across it. The exhaust treatment system 10 of the present disclosure may also meet the government's emissions regulations without including any additional filters or selective catalytic reduction catalysts. Thus, the exhaust treatment system 10 may minimize the space required for packaging and may, thus, fit within, for example, a crowded engine compartment of a conventional work machine. The exhaust treatment system 10 may also be less expensive and less complex than conventional treatment systems using selective catalytic reduction technology to meet 2010 regulations. The operation of the exhaust treatment system 10 will now be explained in detail with reference to FIG. 1.

The power source 12 may combust a mixture of fuel, recirculated exhaust gas, and ambient air to produce mechanical work and an exhaust flow containing the gaseous compounds discussed above. The exhaust flow may be directed, via flow line 16, from the power source 12 through the energy extraction assembly 18. The hot exhaust flow may expand on the blades of the turbine 19 of the energy extraction assembly 18, and this expansion may reduce the pressure of the exhaust flow while assisting in rotating the turbine blades.

The reduced pressure exhaust flow may pass through the regeneration assembly 20. It is understood that the regeneration assembly 20 may be deactivated during the normal operation of the power source 12. Instead, the regeneration assembly 20 may be activated at desired intervals when, for example, the filter 28 becomes at least partially full with collected soot.

The flow may then pass proximate a component of the reactant assembly 21. In particular, the injector 22 may be disposed at least partially within the flow line 16 and the exhaust flow may pass proximate the nozzle 24. The pump 50 may be activated, and the valve 48 may be at least partially opened to direct a quantity of reactant from the reactant supply 52 through the nozzle 24 and into the exhaust flow. The nozzle 24 may inject the reactant as a relatively fine mist, and the reactant may mix substantially uniformly with the exhaust flow in the flow line 16. The exhaust flow/reactant mixture may then pass through the mixer 26 where the mixing may continue. Such substantially uniform mixing may assist in utilizing the full reactive potential of the catalyst materials disposed on the substrate 36 of the filter 28.

As the exhaust flow passes through the filter 28, a portion of the particulate matter entrained with the exhaust flow may be captured by the substrate 36, mesh, and/or other structures within the filter 28. In addition, the catalyst materials disposed on the substrate 36 may assist in chemically reducing the NOx and other harmful pollutants contained in the exhaust flow in the presence of the substantially uniformly mixed reactant. Such selective catalytic reduction systems may remove a substantially greater percentage of NOx from an exhaust flow than nonselective catalytic reduction systems while using substantially less catalyst surface area. Such selective catalytic reduction systems of the present disclosure may also desirably reduce NOx emissions without the substantially increased backpressure associated with multiple-catalyst and/or multiple-particulate filter systems.

The filtered exhaust flow may then pass to the clean-up catalyst 38 where the precious metals making up the substrate 40 may assist in oxidizing any of the reactant still contained in the exhaust flow after passing through the filter 28. The clean-up catalyst 38 may also assist in oxidizing any unburned hydrocarbons contained in the filtered exhaust flow.

A portion of the filtered exhaust flow may be extracted downstream of the clean-up catalyst 38. The extracted portion of the filtered exhaust flow may enter the recirculation line 44 and may be recirculated back to the power source 12. As used herein, the term “filtered exhaust flow” means a flow of exhaust gas in which at least a portion of the particulate matter carried by the flow has been physically separated form the flow by a conventional particulate matter filter or other equivalent apparatus. Removing harmful particulates from the exhaust flow before a portion of the flow is recirculated may assist in reducing the clogging of and/or other damage to the components of the power source 12 over time and may reduce assist in maintaining the efficiency of the combustion reaction within the combustion chamber. It is understood that, for example, NOx, unburned hydrocarbons, and reactants such as urea and ammonia may also be removed from the filtered exhaust flow by the exhaust treatment system 10 of the present disclosure before the filtered exhaust flow is directed to the intake 46 of the power source 12. Although not shown in FIG. 1, it is further understood that, for example, a mixing valve, one or more coolers, and/or a compression assembly may be fluidly connected to the recirculation line 44 to act on the recirculated exhaust flow before the flow enters the intake 46 of the power source 12. After passing through the clean-up catalyst 38, the remainder (the nonextracted portion) of the filtered exhaust flow may exit the exhaust treatment system 10 through the system outlet 42.

Other embodiments of the disclosed exhaust treatment system 10 will be apparent to those skilled in the art from consideration of the specification. For example, in an additional embodiment, the catalyst materials disposed on the substrate 40 of the clean-up catalyst 38 may be disposed on the substrate 36 of the filter 28. In such an embodiment, the clean-up catalyst 38 may be omitted. It is intended that the specification and examples be considered as exemplary only, with the true scope of the invention being indicated by the following claims.

What is claimed is:

1. An exhaust treatment system of a power source, comprising:
a filter fluidly connected to an exhaust outlet of the power source, the filter including a housing and a substrate disposed within the housing, a catalyst material being disposed on the substrate;
a reactant assembly including a reactant supply controllably fluidly connectable to the catalyst material;
a clean-up catalyst downstream of the catalyst material; and
a recirculation line configured to direct a portion of a filtered exhaust flow to an intake of the power source.

2. The system of claim 1, wherein the clean-up catalyst is disposed within a housing separate from the housing of the filter.

3. The system of claim 1, wherein the clean-up catalyst is configured to oxidize at least one of ammonia, carbon monoxide, unburned hydrocarbons, and urea.

4. The system of claim 1, wherein the reactant supply includes a quantity of at least one of urea, carbon monoxide, hydrocarbons, and ammonia.

5. The system of claim 1, wherein the reactant assembly includes an injector disposed upstream of the catalyst material.

6. The system of claim 1, further including a mixer disposed upstream of the catalyst material.

7. The system of claim 1, wherein the substrate is one of substantially metallic and substantially ceramic.

8. The system of claim 1, wherein the filter is a particulate filter.

9. The system of claim 1, wherein the catalyst material includes at least one of a precious metal and a nonprecious metal capable of chemically reducing NOx in the presence of one of urea, hydrocarbons, carbon monoxide, and ammonia.

10. The system of claim 1, further including a regeneration assembly configured to increase the temperature of an exhaust flow of the power source upstream of the filter.

11. An exhaust treatment system of a power source, comprising:
a filter fluidly connected to an exhaust outlet of the power source, the filter including a housing and a substrate disposed within the housing, a catalyst material being disposed on the substrate;
a reactant assembly including a reactant supply controllably fluidly connectable to the catalyst material;
a clean-up catalyst downstream of the catalyst material; and
an energy extraction assembly disposed upstream of the filter and fluidly connected to the exhaust outlet of the power source.

12. The system of claim 11, wherein the clean-up catalyst is disposed within a housing separate from the housing of the filter.

13. The system of claim 11, wherein the clean-up catalyst is configured to oxidize at least one of ammonia, carbon monoxide, unburned hydrocarbons, and urea.

14. The system of claim 11, wherein the reactant supply includes a quantity of at least one of urea, carbon monoxide, hydrocarbons, and ammonia.

15. The system of claim 11, wherein the reactant assembly includes an injector disposed upstream of the catalyst material.

16. The system of claim 11, further including a mixer disposed upstream of the catalyst material.

17. The system of claim 11, wherein the substrate is one of substantially metallic and substantially ceramic.

18. The system of claim 11, wherein the filter is a particulate filter.

19. The system of claim 11, wherein the catalyst material includes at least one of a precious metal and a nonprecious metal capable of chemically reducing NOx in the presence of one of urea, hydrocarbons, carbon monoxide, and ammonia.

20. The system of claim 11, further including a regeneration assembly configured to increase the temperature of an exhaust flow of the power source upstream of the filter.

21. A method of treating an exhaust flow of a power source, comprising:
providing a filter fluidly connected to an exhaust outlet of the power source, the filter including a catalyst material disposed on a substrate, the substrate having a porosity between approximately 55% and approximately 90% in a bare state;
filtering a first portion of the exhaust flow with the substrate;
adding a reactant to the exhaust flow upstream of the catalyst material; and
chemically reducing a second portion of the exhaust flow in the presence of the reactant and the catalyst material.

22. The method of claim 21, further including oxidizing a third portion of the exhaust flow with a clean-up catalyst disposed downstream of the catalyst material.

23. The method of claim 22, wherein the third portion includes at least one of ammonia, urea, carbon monoxide, and unburned hydrocarbons.

24. The method of claim 21, wherein adding a reactant to the exhaust flow includes injecting the reactant.

25. The method of claim 21, wherein the reactant includes at least one of urea, carbon monoxide, hydrocarbons, and ammonia.

26. The method of claim 21, wherein the substrate has a porosity between approximately 40% and approximately 80% in a catalyzed state.

27. The method of claim 21, wherein the first portion includes particulate matter.

28. The method of claim 21, wherein the second portion includes at least one of oxides of nitrogen, hydrocarbons, carbon monoxide, and soluble organic fraction.

29. The method of claim 21, further including reducing the pressure of the exhaust flow upstream of the filter.

30. The method of claim 21, further including directing a portion of the filtered exhaust flow to an intake of the power supply.

31. The method of claim 21, wherein the catalyst material includes at least one of a precious metal and a nonprecious metal capable of chemically reducing oxides of nitrogen in the presence of at least one of urea, hydrocarbons, carbon monoxide, and ammonia.
